(19) United States
(12) Patent Application Publication
(10) Pub. No.: US 2013/0270760 A1
(43) Pub. Date: Oct. 17, 2013

(54) Cantilevered Stop Pin Vise Stop

(71) Applicant: Sean Edward Gordon, Evansville, IN (US)

(72) Inventor: Sean Edward Gordon, Evansville, IN (US)

(21) Appl. No.: 13/447,162

(22) Filed: Apr. 13, 2012

(51) Int. Cl. B23Q 3/18

(52) U.S. Cl. 269/315

(57) ABSTRACT

A device for laterally positioning a work piece in a milling machine vise includes a clamp configured to engage a top longitudinal lip of a vise jaw via at least one clamp screw. The clamp defines a notch configured to receive a work piece facing inner lip edge and an outer lip edge. The notch comprises a top lip resting face, an outer lip clamping face and an inner lip clamping face adjacent the inner lip edge. The device may also include a stop pin. A protrusion extends from the inner lip clamping face to receive the stop pin parallel to the work piece facing inner lip edge. The protrusion is configured to cantilever the stop pin substantially to below the top lip resting face from the inner lip edge of the vise jaw and enable a milling clearance from the clamp to the work piece via the stop pin.

### BACKGROUND AND FIELD OF INVENTION

Before a milling machine operation is performed, the work piece must be properly positioned and held in place on the machining table. Standard table-top vises are used to hold the work piece in place; however, before the vise is locked, the work piece must be accurately positioned in three dimensions within the jaws of the vise.

A machinist may install a stop device at a desired location in a vise and position a metal part to be machined against the stop device. The stop device allows the machinist to position the work piece in a predetermined location before clamping the work piece in the vise. However, the stop device must often be disassembled and removed so that the desired machining operation may be completed on the metal part adjacent the stop. Otherwise, there is a serious risk that the cutting head or other part performing the machining operation will strike the stop. This is likely to cause serious and expensive damage to the drill, cutter or other machine tool.

When a machinist needs to produce multiple work pieces to the same specifications, the machining operation may be performed repetitiously in a tedious manner. Such ‘assembly line’ type machining may require each part to be installed and removed and for the stop device to also be installed and removed. This tends to be an inefficient, time consuming, labor intensive and extremely tedious operation. It is therefore, not at all uncommon for the machine tool operator to forget to remove the positioning stop at any point in time resulting in damage to the stop and/or to the work piece.

A number of solutions have been proposed with limitations. In some instances, devices lack rigidity and may lose their ability to produce accurate positioning of piece after piece in relationship to the cutting tool. This is particularly the case where the device or stop is multi-jointed and includes excessive joints and degrees of movement or rotation. Other problems may arise where the vise stop effectively limits access of the machine tool or the cutting tool to various surfaces of the work piece. In some instances, the configuration of the vise stop device limits the ability of the cutting tool to access only the top surface of the work piece.

There is a long felt need in the market for a simple and reliable vise stop device which allows repetitious placement of a work piece along the longitudinal axis in relation to the cutting tool. Machinists have long needed a stop device which allows the work piece to be accurately and safely machined on all surfaces exposed to the cutting tool without taking the work piece out of the vise and turning it around for subsequent machining

### SUMMARY OF THE INVENTION

A device for laterally positioning a work piece adjacent a stop pin disposed parallel to and between opposing vise jaws of a milling machine vise is disclosed. The device includes a clamp configured to engage a top longitudinal lip of a vise jaw via at least one clamp screw. The clamp defines a channel configured to receive a work piece facing inner lip edge and an outer lip edge. The channel comprises a top lip resting face and an inner lip clamping face adjacent the vise jaw inner lip edge and an outer lip clamping face adjacent the vise jaw outer lip edge. A stop pin may also be included in the device. A protrusion extends from the inner lip clamping face to receive the stop pin parallel to the work piece facing inner lip edge of the vise jaw. The protrusion is configured to cantilever the stop pin substantially below the top lip resting face from the inner lip edge of the vise jaw and enable a milling clearance from the clamp to the work piece via the stop pin.

A device for longitudinally positioning a work piece in a milling machine vise is also disclosed. The device comprises a clamp configured to engage a top longitudinal lip of a vise jaw via at least one clamp screw. The clamp defines a channel configured to receive a work piece facing inner lip edge of the vise jaw and an outer lip edge of the vise jaw. The channel comprises a top lip resting face and an inner lip clamping face adjacent the vise jaw inner lip edge and an outer lip clamping face adjacent the vise jaw outer lip edge. A protrusion extends from the inner lip clamping face substantially below the top lip resting face and extends parallel to and beyond a longitudinal width of the device. The protrusion is configured to cantilever from the inner lip edge of the vise jaw and provide a milling clearance from the clamp to the work piece.

The disclosed device(s) further comprise a first and a second stop member configured to extend from a respective first and a second longitudinal length of the protrusion and provide a first and a second independently adjustable clearance between a first and a second work piece, each stop member configured to extend parallel to and between a pair of opposing vise jaws of the milling machine vise.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a top perspective view of a work piece positioning device with a stop pin cantilevered from a top lip of a vise jaw in accordance with an embodiment of the present disclosure.

FIG. 2 is a top perspective view of a work piece positioning device with a stop pin cantilevered from an inner lip clamping face in accordance with a disclosed embodiment.

FIG. 3 is a side elevational view of a work piece positioning device with a stop pin cantilevered from an inner lip clamping face in accordance with a disclosed embodiment.

FIG. 4 is a top perspective view of a two-part work piece positioning device with a stop pin cantilevered from an inner lip clamping face in accordance with a disclosed embodiment.

FIG. 5 is a side elevational view of a two-part work piece positioning device with a stop pin cantilevered from an inner lip clamping face in accordance with a disclosed embodiment.

FIG. 6 is a top elevational view of a two-part work piece positioning device with a stop pin cantilevered from an inner lip clamping face in accordance with a disclosed embodiment.

FIG. 7 is a bottom elevational view of a two-part work piece positioning device with a stop pin cantilevered from an inner lip clamping face in accordance with a disclosed embodiment.

FIG. 8 is a front elevational view of a two-part work piece positioning device with a stop pin cantilevered from an inner lip clamping face in accordance with a disclosed embodiment.

FIG. 9 is a back elevational view of a two-part work piece positioning device with a stop pin cantilevered from an inner lip clamping face in accordance with a disclosed embodiment.

FIG. 10 is a top elevational view of a two-part work piece positioning device with a stop protrusion cantilevered from the inner lip clamping face in accordance with a disclosed embodiment.

FIG. 11 is a bottom elevational view of a two-part work piece positioning device with a slotted stop bar cantilevered from an inner lip clamping face in accordance with a disclosed embodiment.

FIG. 12 is a bottom elevational view of an exploded work piece positioning device with a stop pin cantilevered from an inner lip clamping face in accordance with a disclosed embodiment.

FIG. 13 is a bottom elevational view of an exploded two-part work piece positioning device with a stop pin cantilevered from an inner lip clamping face in accordance with a disclosed embodiment.

FIG. 14 is a top perspective view of a dual work piece positioning device with a two-piece adjustable stop pin cantilevered from a top lip of a vise jaw in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having to possession of this disclosure, are to be considered within the scope of the invention.

The term ‘channel’ as used throughout the present disclosure defines at least three faces or surfaces of the disclosed device for receiving at least three complementary faces or surfaces of a vise jaw. The term channel comprises like terms such as notch, recess, pocket, etc that define a shaped void in the disclosed device suitable for clamping onto a lip of a vise jaw. The term ‘longitudinally’ as used throughout the present disclosure defines a lengthwise dimension or a longer distinguishing dimension of a vise jaw. Various terms may be used to refer to the disclosure, including but not limited to vise jaw stop, work positioning device, vise stop clamp, stop clamp and so forth. Also, all dimensions specified herein include a plus or minus ten percent tolerance for manufacturing and vendor interchangeability.

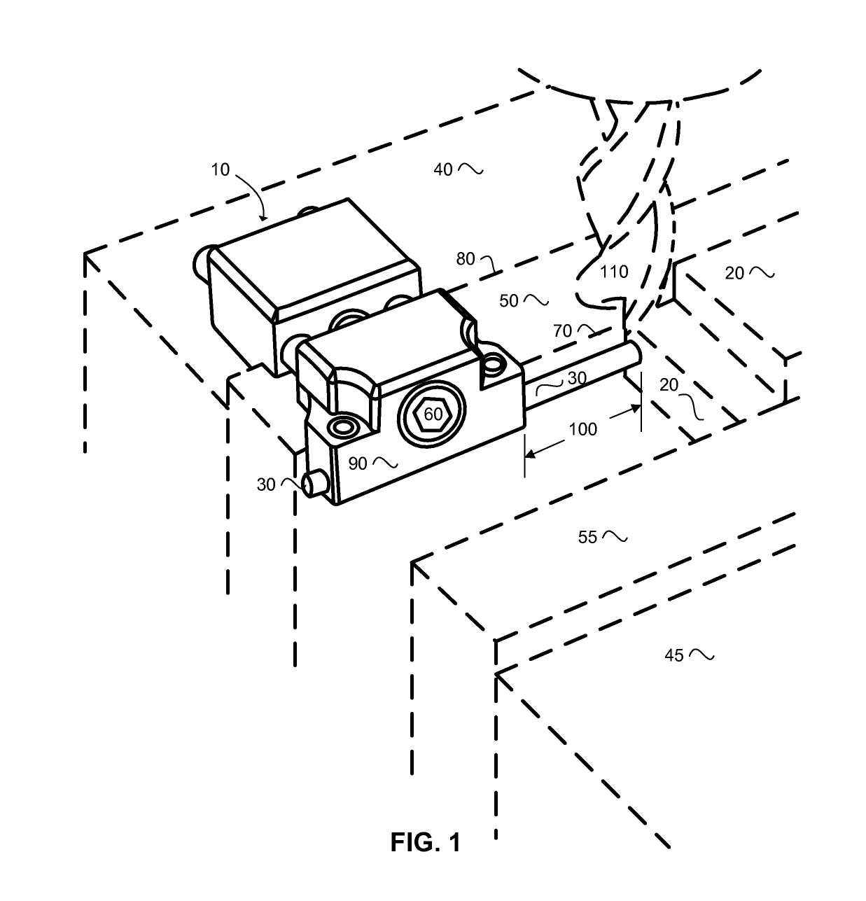

FIG. 1 is a top perspective view of a work piece positioning device with a stop pin cantilevered from a top lip of a vise jaw in accordance with an embodiment of the present disclosure. The disclosed device 10 laterally or longitudinally allows the positioning of a work piece 20 adjacent a stop pin 30 disposed parallel to and between opposing vise jaws 40 and 45 of a milling machine vise. The device 10 includes a clamp configured to engage a top longitudinal lip 50 of a vise jaw 40 via at least one clamp screw 60. The clamp defines a channel (not depicted) configured to receive a work piece facing inner lip edge 70 of the vise jaw and an outer lip edge 80 of the vise jaw. The channel comprises a top lip resting face and an inner lip clamping face adjacent the vise jaw inner lip edge and an outer lip clamping face adjacent the vise jaw outer lip edge (see FIG. 3 and FIG. 5). A stop pin 30 may also be included in the device 10. A protrusion 90 extends from the inner lip clamping face to receive the stop pin 30 parallel to the work piece facing inner lip edge 70 of the vise jaw. The protrusion 90 is configured to cantilever the stop pin 30 substantially below the top lip resting face from the inner lip edge 70 of the vise jaw and enable a milling clearance 100 from the clamp device 10 to the work piece 20 via the stop pin 30. The milling clearance 100 allows a milling cutter 110 to pass through the work piece 20 without the risk of cutting or damaging the device 10. The disclosed stop device 10 may clamp to either of the two vise jaw lips 50 and 55.

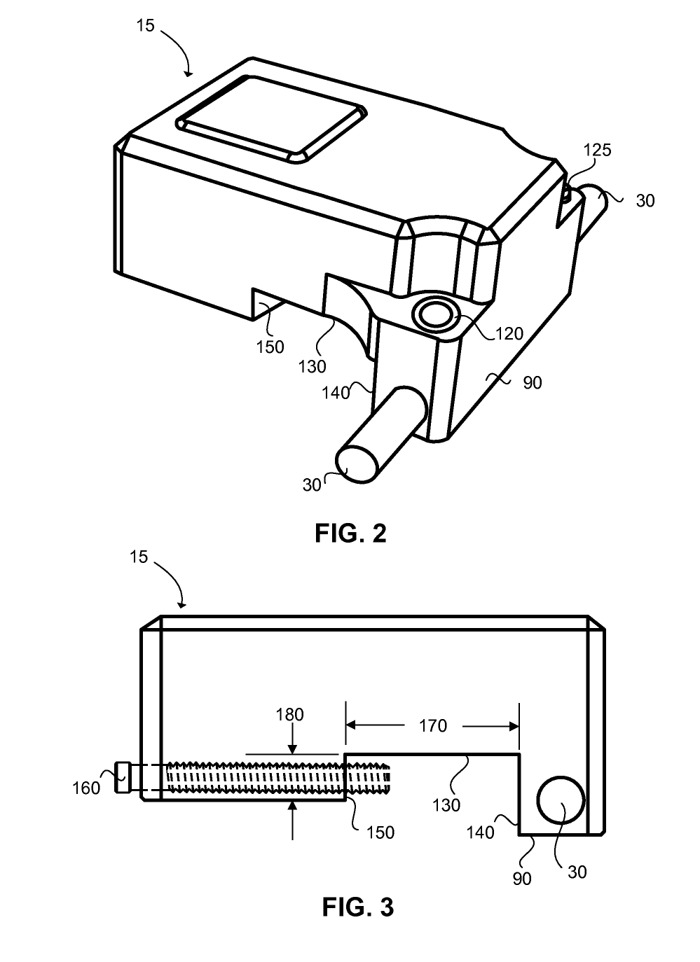

FIG. 2 is a top perspective view of a work piece positioning device with a stop pin cantilevered from an inner lip clamping face in accordance with a disclosed embodiment. The work piece positioning device 15 further comprises at least one adjustable non-marring flat point set screw 120 and 125 threadedly engaged in one of the clamp and the clamp protrusion 90. The at least one adjustable set screw 120 may be configured to fix a position of the stop pin 30 relative to one of the clamp and clamp protrusion 90 and thereby enable a variable milling cutter clearance 100 (not depicted) between the clamp device 15 and the work piece 20 (also not depicted). The channel comprises a top lip resting face 130 and an inner lip clamping face 140 adjacent the inner lip edge 70 of the vise jaw and an outer lip clamping face 150 adjacent the outer lip edge 80 of the vise jaw 40 (not shown).

FIG. 3 is a side elevational view of a work piece positioning device with a stop pin cantilevered from an inner lip clamping face in accordance with a disclosed embodiment. The work piece positioning device 15 depicted comprises a stop pin 30, at least one clamp screw 160, a stop protrusion 90, a top list resting face 130, an inner lip clamping face 140 and an outer lip clamping face 150. The at least one clamp screw 160, shown in broken lines, is threaded engaged with the clamp stop 15 and therefore enables the clamp stop 15 to engage the top lip 50 of the vise jaw 40 (not depicted) via the outer lip clamping face 150 when turned by a machinist or operator. The clamp channel may therefore comprise the top lip resting face 130 and both the inner and outer lip clamping faces 140 and 150 respectively. The clamp stop channel and clamp screw 160 enable the clamp stop to engage a top lip of the vise jaw having a jaw thickness between one-half of an inch and seven-eighths of an inch (12.70 mm to 22.23 mm) depicted as dimension 170.

An embodiment of the work piece positioning device includes a second lip clamping face measuring a nominal one-eighth inch depicted as dimension 180. This dimension of the second lip clamping face enables clamping the device onto a one-eighth inch vise jaw protrusion (3.18 mm)

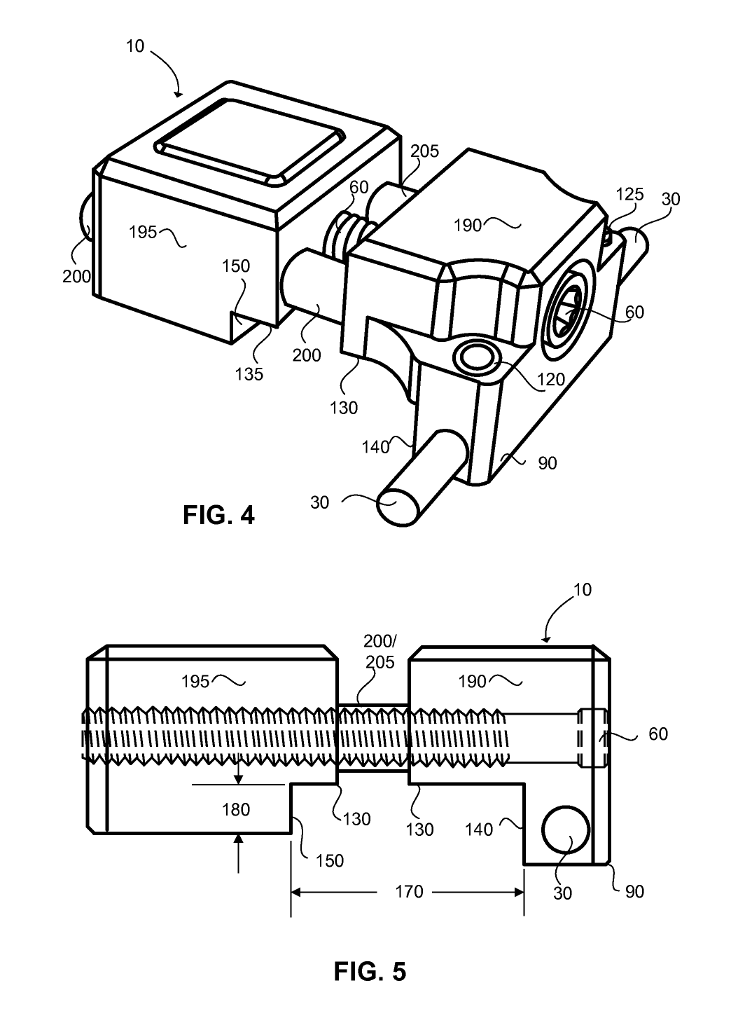

FIG. 4 is a top perspective view of a two-part work piece positioning device with a stop pin cantilevered from an inner lip clamping face in accordance with a disclosed embodiment. The work piece positioning device 10 is bifurcated into a first clamp member 190 and second clamp member 195. The first clamp member 190 comprises a first top lip resting face 130, an inner lip clamping face 140, a stop protrusion 90, two adjustable non-marring flat point set screws 120 and 125. The adjustable set screws 120 and 125 may be threadedly engaged in one of the clamp 10 and the clamp protrusion 90 to fix a position of the stop pin 30 relative to one of the clamp 10 and clamp protrusion 90 and thereby enable a variable milling cutter clearance 100 (not depicted) between the clamp device 10 and the work piece 20 (also not depicted). The second clamp member 195 comprises a second top lip resting face 135 and the outer lip clamping face 150. The work piece positioning device channel or notch may therefore comprise the top lip resting faces 130, 135 and the inner lip clamping face 140 and the outer lip clamping face 150. The first and second clamp members are threadedly engaged via the at least one clamp screw 60 shown in broken lines. The guide pins 200 and 205 may be disposed parallel with the clamp screw 60 and slidably received into one of the first clamp member 190 and the second clamp member 195 and fixedly received into the other clamp member.

In an embodiment of the present disclosure, the work piece positioning device 10 further comprises a guide pin disposed on each of two sides of the clamp screw 60 and are parallel with the clamp screw 60 and fixedly received into the first clamp member 190 and slidably received into the second clamp member 195. Also, the first and second members 190 and 195 may be threadedly engaged with the at least one clamp screw 60 and the other member may be slidably engaged with the at least one clamp screw 60.

FIG. 5 is a side elevational view of a two-part work piece positioning device with a stop pin cantilevered from an inner lip clamping face in accordance with a disclosed embodiment. The work piece positioning device 10 depicted comprises a stop pin 30, at least one clamp screw 60, a stop protrusion 90, a top list resting face 130 and 135, an inner lip clamping face 140 and an outer lip clamping face 150. The clamp screw 60 shown in broken lines, is threaded engaged with the clamp stop 10 and therefore enables the clamp stop 10 to engage the top lip 50 of the vise jaw 40 (not depicted) via the inner and outer lip clamping faces 140 and 150 when turned by a machinist or operator. The clamp channel and clamp screw 60 enable the clamp stop 10 to engage a top lip of the vise jaw having a jaw thickness between one-half of an inch and seven-eighths of an inch (12.70 mm to 22.23 mm) depicted as dimension 170.

An embodiment of the work piece positioning device comprises a height of the outer lip clamping face measuring a nominal one-eighth inch depicted as dimension 180. The dimension of the outer lip clamping face enables clamping the device onto a one-eighth inch vise jaw protrusion (3.18 mm)

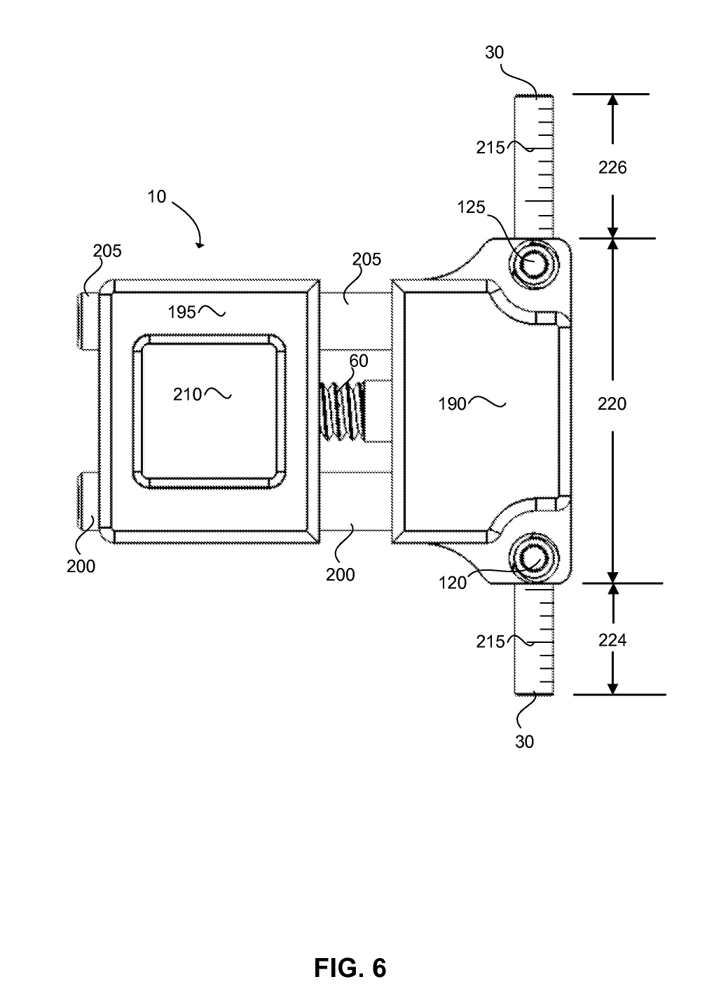

FIG. 6 is a top elevational view of a two-part work piece positioning device with a stop pin cantilevered from an inner lip clamping face in accordance with a disclosed embodiment. The disclosed vise stop clamping and positioning device 10 comprises a stop rod or pin 30, a clamp screw 60, adjustable set screws 120 and 125, a first and a second clamping member 190 and 195, a first and a second guide rod or pin 200 and 205 and a name plate 210. A longitudinal width 220 of the first and second clamp members 190 and 195 may measure a nominal one and one-eighth an inch (28.58 mm) Dimensions 224 and 226 correspond to a first work piece clearance and a second work piece clearance to the vise stop work piece positioning device. The disclosed stop may therefore provide a clearance for two work pieces at the same time positioned on either side of the disclosed stop.

An embodiment of the present disclosure includes a separate stop pin for the first clearance to a first work piece and the second clearance to the second work piece so the dimensions 224 and 226 are independent of each other.

Therefore, multiple work positioning devices may be disposed on the vise jaw lip to enable positioning many work pieces there between of a same or a substantially same width and various lengths.

The name plate 210 may indicate the manufacturer, the seller, and any other marketer of the disclosed work piece positioning device including the trademarks ‘Edge Technology™’ and ‘Edge Technology Products™’ and any variation thereof. The name plate may also indicate the given name of the work piece positioning device also known as a vise work stop and any other name used in commerce for consumer recognition.

In an embodiment of the disclosure, a magnetic stop pin may be configured to magnetically adhere to the stop pin protrusion in a predetermined and fixed longitudinal relationship to the protrusion. There may therefore be a transverse slot in one of the magnetic stop pin and the protrusion and a complementary transverse post, bump or extrusion in the other to enable the magnetic stop pin to fixedly engage with the stop protrusion.

In another embodiment of the disclosure, a graduated indicia 215 and/or markings may be included on one of the stop member/pin/rod etc and the protrusion. The indicia and/or markings 215 enable a machinist user to precisely set a milling cutter clearance between the clamp stop device and a work piece. The indicia and/or markings 215 may be engraved, embossed, printed and otherwise fixed onto the work piece positioning device in either the metric system of measurement or the English system of measurement. The indicia and/or markings may include numbers, letters and any other type of marking indicating length, width, difference and other measurements indicative of the clearance between the vise stop device and the work piece via the stop pin.

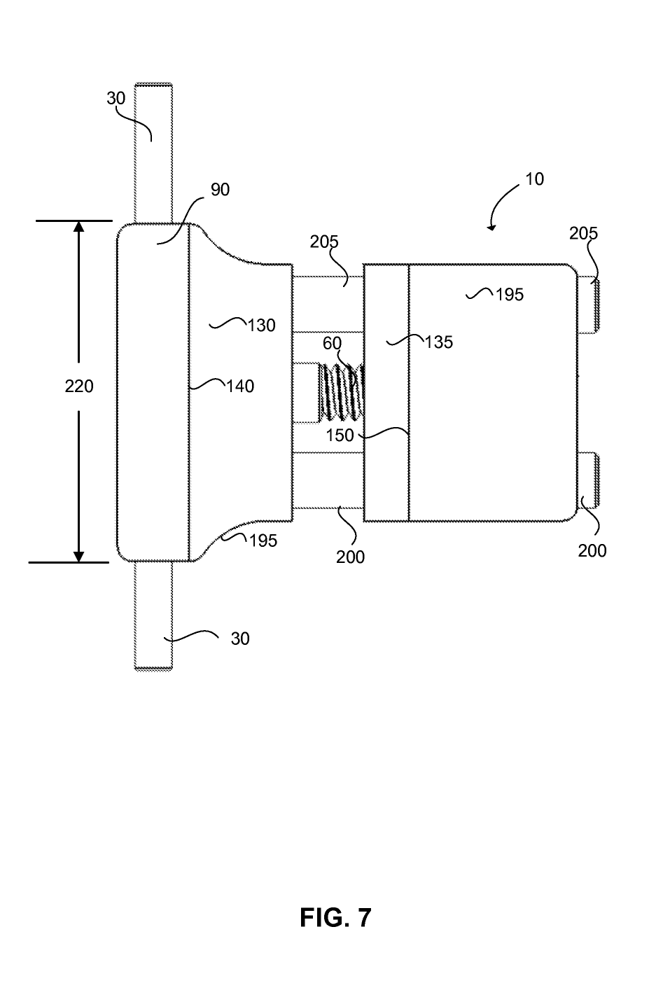

FIG. 7 is a bottom elevational view of a two-part work piece positioning device with a stop pin cantilevered from an inner lip clamping face in accordance with a disclosed embodiment. The depiction shows the first clamp member 190, the stop pin 30, the bottom face of the stop protrusion 90, the clamping faces 140 and 150, the resting faces 130 and 135, the clamp screw 60, the guide pins 200 and 205 and the second clamp member 195.

In an embodiment of the disclosure, the stop member may be a rod comprising at least one post and the protrusion comprising at least one slot configured to receive one of the posts to enable a post-slot locking of the stop member in relation to the protrusion and thus enable a variable cutter clearance between the clamp device and the work piece.

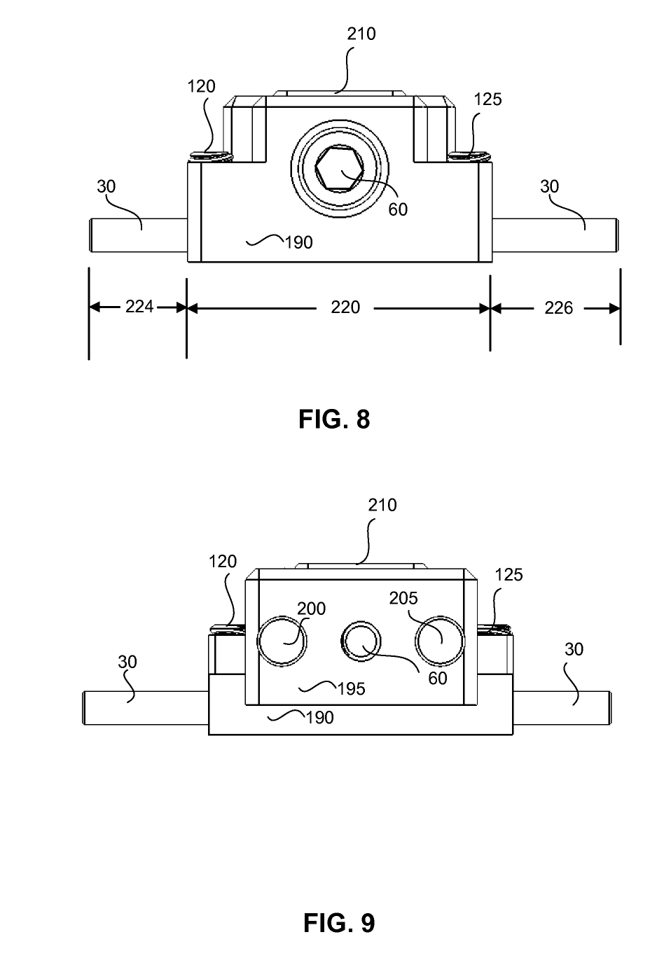

FIG. 8 is a front elevational view of a two-part work piece positioning device with a stop pin cantilevered from an inner lip clamping face in accordance with a disclosed embodiment. The depiction shows the stop pin 30, head of the clamp screw 60, the adjustable set screws 120 and 125, the first clamp member 190 and the name plate 210 on the second clamp member 195. The clamp screw 60 may be recessed into the clamp stop 10 and may comprises one of a hexagonal head, an alien head and any other screw head type configured to enable a user to turn the clamp screw via a complementary keyed driver and clamp the device onto a vise jaw lip.

FIG. 9 is a back elevational view of a two-part work piece positioning device with a stop pin cantilevered from an inner lip clamping face in accordance with a disclosed embodiment. The depiction shows the stop pin 30, the end of the clamp screw 60, the adjustable set screws 120 and 125, the first clamp member 190 and the second clamp member 195, the end of the guide pins 200 and 205 and the name plate 210. The first and second clamp members 190 and 195 may comprise anodized aluminum and the stop pin may comprise hardened stainless steel.

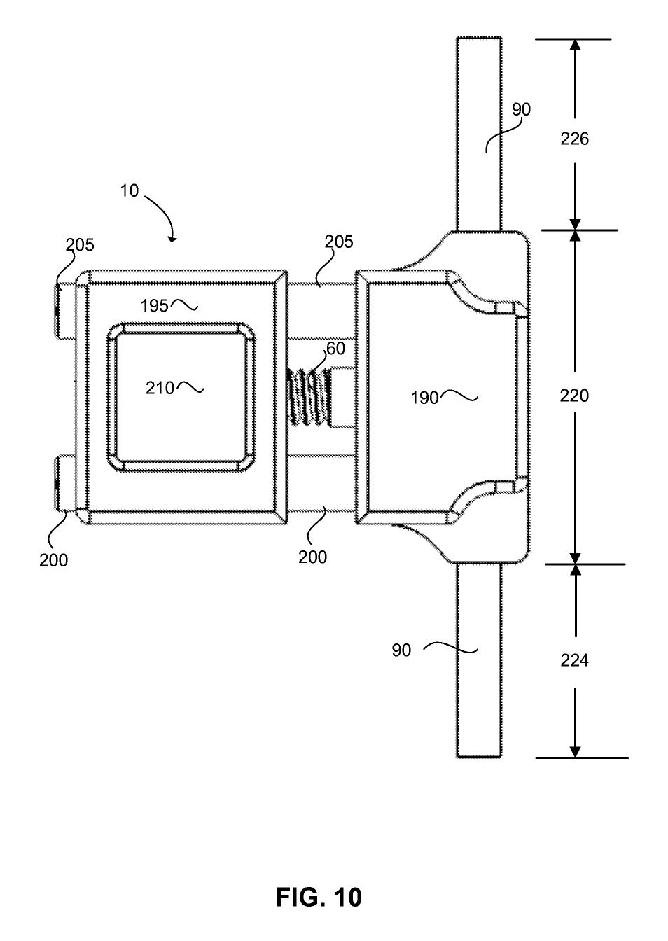

FIG. 10 is a top elevational view of a two-part work piece positioning device with a stop protrusion cantilevered from the inner lip clamping face in accordance with a disclosed embodiment. The disclosed vise stop clamping and positioning device 10 comprises a clamp screw 60, a stop protrusion 90, adjustable set screws 120 and 125, a first and a second clamping member 190 and 195, a first and a second guide rod or pin 200 and 205 and a name plate 210. The stop protrusion 90 extends from the inner lip clamping face substantially below the top lip resting face and extends parallel to and beyond a longitudinal width 220 of the device. The stop protrusion 90 forms a stop pin itself and therefore not require a discrete stop pin to provide a milling clearance to a work piece. The protrusion 90 is configured to cantilever from the inner lip edge 70 of the vise jaw lip 50 (not shown) and directly provide the milling clearance from the clamp to the work piece.

In an embodiment of the disclosure, a magnetic stop pin 30 may be configured to magnetically adhere to the stop pin protrusion in a predetermined and fixed longitudinal relationship to the protrusion. The stop pin 30 may be configured as one of a pin, a rod, a bar and any like geometry to provide a milling cutter clearance from the longitudinal width of the clamp device to the work piece via the protrusion.

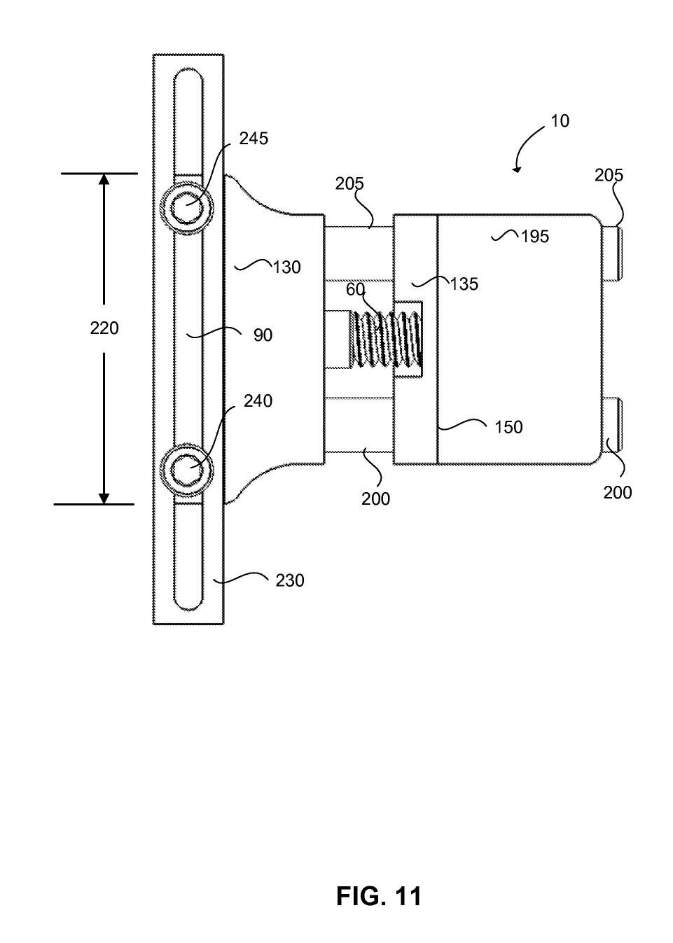

FIG. 11 is a bottom elevational view of a two-part work piece positioning device with a slotted stop bar cantilevered from an inner lip clamping face in accordance with a disclosed embodiment. The depiction shows the clamp screw 60, the bottom face of the stop protrusion 90, the resting faces 130 and 135, and the first and second clamp members 190 and 195, the guide pins 200 and 205 and the slotted stop bar 230. The screws 240 and 245 hold the stop bar in place relative to the work piece positioning device 10. The stop member or stop bar 230 comprises a channel therein to receive at least one screw to set the stop member in relation to the protrusion and thus enable a variable cutter clearance between the clamp device and the work piece.

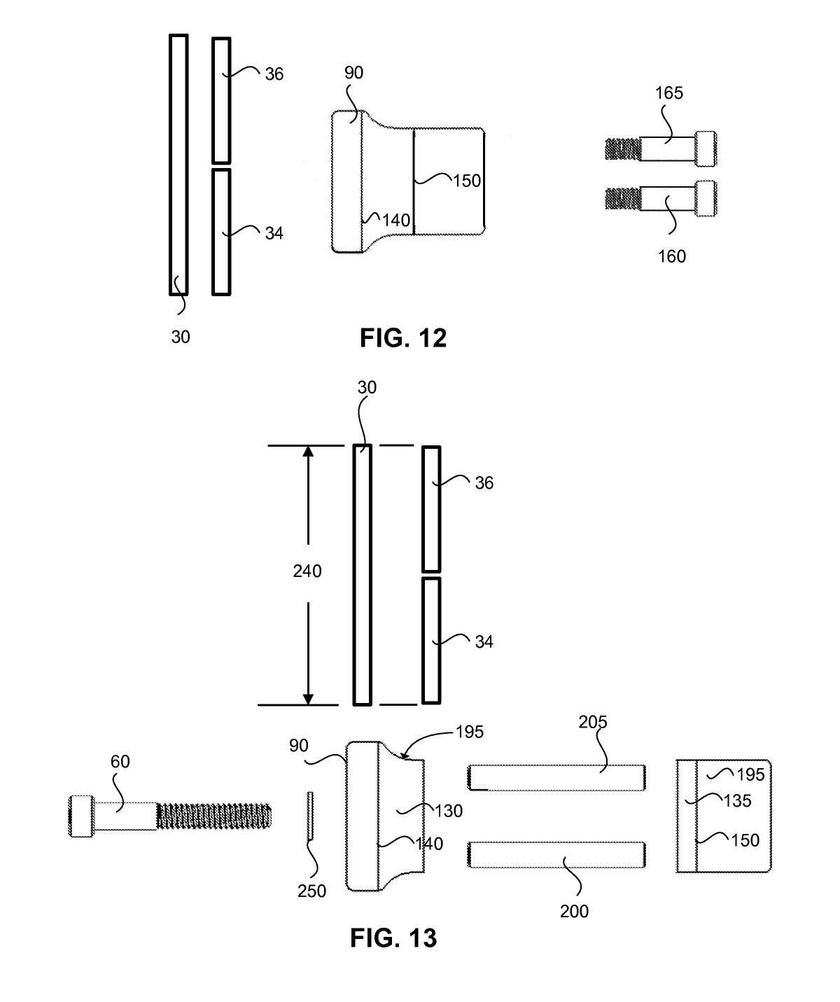

FIG. 12 is an exploded bottom elevational view of a work piece positioning device with a stop pin cantilevered from an inner lip clamping face in accordance with a disclosed embodiment. The view depicts the bottom surface of the stop protrusion 90, the inner lip clamping face 140 and the outer lip clamping face 150 and two clamp screws 160 and 165. The work piece positioning device 15 may be configured to receive a single hardened steel rod 30 or a two-piece steel rod 34 and 36. The stop rod or pin 30, 34 and 36 may measure a nominal one-eighth inches in diameter (3.18 mm) and wherein a length of the stop member exceeds a longitudinal width of the clamp device to enable a milling cutter clearance between the clamp device and the work piece.

FIG. 13 is an exploded bottom elevational view of a two-part work piece positioning device with a stop pin cantilevered from an inner lip clamping face in accordance with a disclosed embodiment. The view depicts the clamp screw 60, a washer 250 for the clamp screw 60, a bottom surface of the stop protrusion 90, the inner lip clamping face 140, the resting faces 130 and 135, the outer lip clamping face 150 and the guide pins 200 and 205. The work piece positioning device 15 may be configured to receive a single hardened steel rod 30 or a two-piece steel rod 34 and 36. A stop member or pin may comprise two stop pins where each stop pin is configured to extend from a longitudinal length of the protrusion and provide an independently adjustable clearance from the device to at least one separate work piece positioned on either side of the device protrusion.

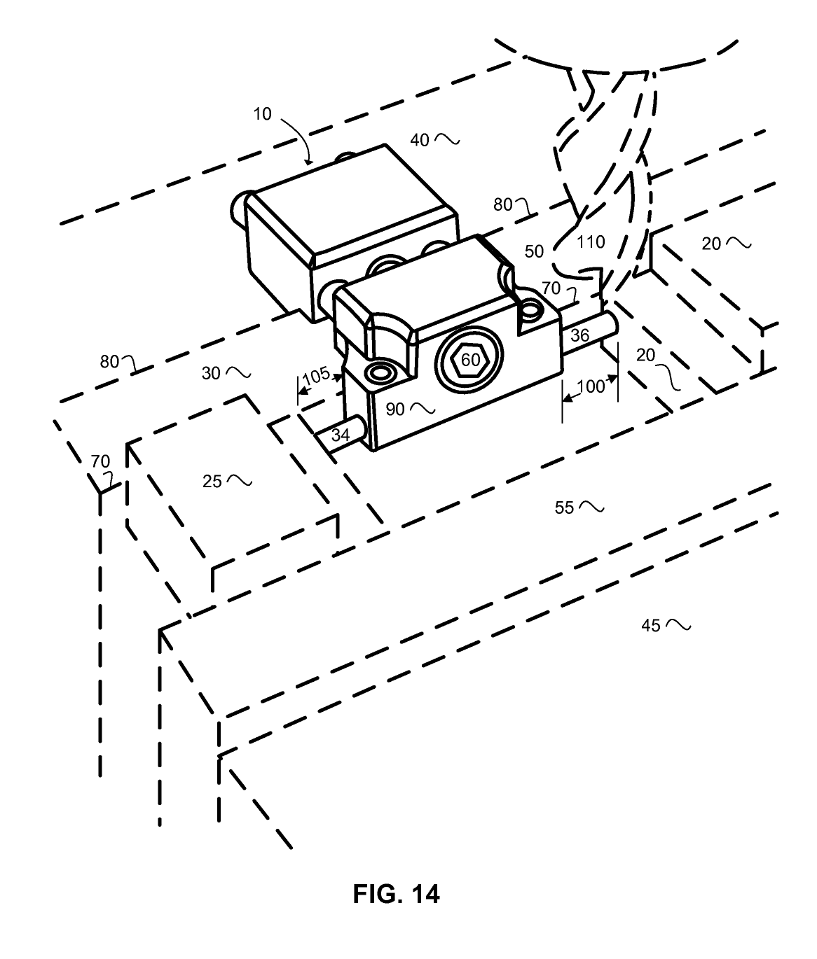

FIG. 14 is a top perspective view of a dual work piece positioning device with a two-piece adjustable stop pin cantilevered from a top lip of a vise jaw in accordance with an embodiment of the present disclosure. The depiction includes all of the elements of FIG. 1 with the addition of a second work piece 25, a first and second stop pin 34 and 36 and a second independently adjustable clearance 105 from the vise stop clamp to the work piece 25. The clearance 105 is independently adjustable because stop pin 34 is independent of stop pin 36 and each is secureable via its respective set screw. A space between the two work pieces, otherwise inaccessible to conventional vise jaw stops, is accessible to the vise jaw stop of the disclosure because the disclosed positioning device clamps onto the lip of a vise jaw and cantilevers at least one stop pin from an inside longitudinal lip 70 of the vise jaw.

An embodiment of the disclosed device(s) may therefore further comprise a first and a second stop member configured to extend from a respective first and a second longitudinal length of the protrusion and provide a first and a second independently adjustable clearance between a first and a second work piece, each stop member configured to extend parallel to and between a pair of opposing vise jaws of the milling machine vise.

Because the present disclosure includes a separate adjustable stop pin for a first clearance to a first work piece and the second clearance to a second work piece, multiple vise stop devices as disclosed may be disposed on the vise jaw lip to enable positioning many work pieces there between of a same or a substantially same width and various lengths. The disclosed stop may therefore provide a clearance for two work pieces at the same time positioned on either side of a disclosed stop. This is a distinctive and distinguishing feature of the disclosure over the prior art which may only provide a stop for a single work piece. The disclosure then allows a machinist to position and produce several identical work pieces in a single vise clamp.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A device for laterally positioning a work piece adjacent a stop pin disposed parallel to and between opposing vise jaws of a milling machine vise, the device comprising:
a clamp configured to engage a top longitudinal lip of a vise jaw via at least one clamp screw, the clamp defining a channel configured to receive a work piece facing inner lip edge and an outer lip edge, the channel comprising a top lip resting face and an inner lip clamping face adjacent the inner lip edge and an outer lip clamping face adjacent the outer lip edge; and
a protrusion extending from the inner lip clamping face to receive the stop pin parallel to the work piece facing inner lip edge, the protrusion configured to cantilever the stop pin substantially below the top lip resting face from the inner lip edge of the vise jaw and enable a milling clearance from the clamp to the work piece via the stop pin.

2. The work piece positioning device of claim 1, further comprising at least one non-marring flat point set screw threadedly engaged in one of the clamp and the clamp protrusion, the at least one set screw configured to fix a position of the stop pin relative to one of the clamp and clamp protrusion and thereby enable a variable milling cutter clearance between the clamp device and the work piece.

3. The work piece positioning device of claim 1, wherein the at least one clamp screw is configured to enable the clamp to engage the top lip of the vise jaw having a jaw thickness between 12.7 mm and 22.23 mm (one-half of an inch and seven-eighths of an inch) plus or minus a ten percent tolerance.

4. The work piece positioning device of claim 1, wherein a height of the second lip clamping face measures a nominal 3.18 mm (one-eighth inch) plus or minus a ten percent tolerance to enable clamping the device onto a one-eighth inch vise jaw protrusion.

5. The work piece positioning device of claim 1, further comprising a magnetic stop pin configured to magnetically adhere to the stop pin protrusion in a predetermined and fixed longitudinal relationship to the protrusion.

6. The work piece positioning device of claim 1, wherein the clamp device is bifurcated into a first clamp member and second clamp member, the first clamp member comprising a first top lip resting face and the inner lip clamping face and the second clamp member comprising a second top lip resting face and the outer lip clamping face and wherein the first and second clamp members are engaged via the at least one clamp screw.

7. The work piece positioning device of claim 6, further comprising one of the first and second members threadedly engaged with the at least one clamp screw and the other member slidably engaged with the at least one clamp screw.

8. The work piece positioning device of claim 6, further comprising at least one guide pin disposed parallel with the clamp screw and slidably received into one of the first clamp member and the second clamp member and fixedly received into the other clamp member.

9. The work piece positioning device of claim 6, further comprising a guide pin disposed on each of two sides of a clamp screw and parallel with the clamp screw and fixedly received into the first clamp member and slidably received into the second clamp member.

10. The work piece positioning device of claim 6, wherein a longitudinal width of the first and second clamp members measures a nominal 28.58 mm (one and one-eighth an inch) plus or minus a ten percent tolerance.

11. The work piece positioning device of claim 6, wherein the first and second clamp members comprise anodized aluminum and the stop pin comprises hardened stainless steel.

12. A device for laterally positioning a work piece in a milling machine vise, the device comprising (one piece molded stop):
a clamp configured to engage a top longitudinal lip of a vise jaw via at least one clamp screw, the clamp defining a channel configured to receive a work piece facing inner lip edge and an outer lip edge, the channel comprising a top lip resting face and an inner lip clamping face adjacent the inner lip edge and an outer lip clamping face adjacent the outer lip edge; and
a protrusion extending from the inner lip clamping face substantially below the top lip resting face and extending parallel to and beyond a longitudinal width of the device, the protrusion configured to cantilever from the inner lip edge of the vise jaw and provide a milling clearance from the clamp to the work piece.

13. The work piece positioning device of claim 12, wherein the clamp protrusion is configured as one of a pin, a rod, a bar and any like geometry to provide a milling cutter clearance from the longitudinal width of the clamp device to the work piece via the protrusion.

14. The work piece positioning device of claim 12, wherein the clamp screw is recessed into the clamp and comprises one of a hex head, an allen head and any other screw head type configured to enable a user to turn the clamp screw via a key driver and clamp the device onto a vise jaw lip.

15. A device for laterally positioning a work piece in a milling machine vise, the device comprising:
a clamp configured to engage a top longitudinal lip of a vise jaw via at least one clamp screw, the clamp defining a channel configured to receive a work piece facing inner lip edge and an outer lip edge, the channel comprising a top lip resting face and an inner lip clamping face adjacent the inner lip edge and an outer lip clamping face adjacent the outer lip edge;
a stop member; and
a protrusion extending from the inner lip clamping face to receive the stop member parallel to the work piece facing inner lip edge, the protrusion configured to cantilever the stop member substantially below the top lip resting face from the inner lip edge of the vise jaw and enable a milling clearance from the clamp to the work piece via the stop member.

16. The work piece positioning device of claim 15, further comprising a first and a second stop member configured to extend from a respective first and a second longitudinal length of the protrusion and provide a first and a second independently adjustable clearance between a first and a second work piece, each stop member configured to extend parallel to and between a pair of opposing vise jaws of the milling machine vise.

17. The work piece positioning device of claim 15, further comprising a graduated indicia on one of the stop member and the protrusion, the indicia configured to enable a user to precisely set a milling cutter clearance between the clamp device and the work piece.

18. The work piece positioning device of claim 15, wherein the stop member is a rod comprising at least one post and the protrusion comprises at least one slot configured to receive one of the posts to enable a post-slot locking of the stop member in relation to the protrusion and thus enable a variable cutter clearance between the clamp device and the work piece.

19. The work piece positioning device of claim 15, wherein the stop member is a bar comprising a channel therein configured to receive at least one screw to set the stop member in relation to the protrusion and thus enable a variable cutter clearance between the clamp device and the work piece.

20. The work piece positioning device of claim 15, wherein the stop member is a hardened steel rod measuring a nominal 3.18 mm (one-eighth inches) in diameter plus or minus a ten percent tolerance and wherein a length of the stop member exceeds a longitudinal width of the clamp device to enable a milling cutter clearance between the clamp device and the work piece.
